(19) United States
(12) Patent Application Publication
(10) Pub. No.: US 2025/0257258 A1
(43) Pub. Date: Aug. 14, 2025

(54) Chemical Additive Sand Washing

(71) Applicant: ChampionX LLC, Sugar Land, TX (US)

(72) Inventors: Shawn Brendan Fitch, Katy, TX (US); Tzu-Ping Hsu, Katy, TX (US); Christopher Waller, Houston, TX (US); Kai He, Sugar Land, TX (US)

(21) Appl. No.: 19/052,534

(22) Filed: Feb. 13, 2025

Related U.S. Application Data
(60) Provisional application No. 63/552,904, filed on Feb. 13, 2024.

(51) Int. Cl. C09K 8/80; C09C 1/30; E21B 43/267

(52) U.S. Cl. CPC C09K 8/80; C09C 1/3009; C09C 1/3063; C09C 1/3072; E21B 43/267; C01P 2004/61; C01P 2006/80

(57) ABSTRACT

Methods and compositions utilize a sand obtained by combining a dirty sand with a chemical additive, where the combination decreases the water drain time through the sand compared to the sand without the chemical additive. The decrease of water drain time reduces the amount of time to dry the sand after a wash, and when using the sand for proppant, promotes conductivity of fluid through the sand when the sand is in a fracture of a subterranean formation.

### CROSS-REFERENCE TO RELATED APPLICATIONS

This application is a non-provisional patent application claiming the benefit of, and priority to, U.S. Provisional Patent Application No. 63/552,904, filed Feb. 13, 2024, which is incorporated by reference herein in its entirety.

### FIELD OF THE DISCLOSURE

The present disclosure generally relates to treatment of sand to obtain a treated sand.

### BACKGROUND

Sand is used in hydraulic fracturing of subterranean formations. The sand, also referred to as proppant, props open fractures in the subterranean formation that facilitates production of hydrocarbons from the fractured formation.

Sand at the surface may be treated prior to mixing with a fluid for use as a proppant in the subterranean formation. For treatment, sand is sometimes washed, then subjected to drying or draining of liquids from the sand at ambient conditions, then subjected to drying at an elevated temperature. The dried sand can then be sorted or sized for use. Drying or draining at ambient temperature can take a long time (e.g., 2-7 days), and drying at elevated temperature is energy intensive (e.g., typically requiring the burning of large volumes of natural gas to produce the heat needed).

There is a need to reduce the sand drying time at ambient temperature and/or at elevated temperatures.

### SUMMARY

A method for processing sand can include: combining a dirty sand, water, and a chemical additive to form a first mixture, wherein the chemical additive is present in a range of from 100 ppm to 3,000 ppm based on a total weight or a total volume of the first mixture; removing a first portion of the water from the first mixture to form a second mixture; and heating the second mixture to remove a second portion of the water, forming a treated sand. Water can be present in a range of from 15 wt % to 20 wt % based on a total weight of the first mixture and in a range of from 1 wt % to 5 wt % based on a total weight of the second mixture.

A method can include: combining, on a well site, a dirty sand, water, and a chemical additive, in any order to form a proppant mixture; and introducing, at the well site, the proppant mixture into a fracture of a subterranean formation via a wellbore.

A composition having components and features disclosed herein when the composition is prepared by treating a dirty sand according to a method disclosed herein.

A composition including a proppant sand and any components and features disclosed herein when the composition is prepared by treating a dirty sand according to a method disclosed herein.

A composition including a treated sand and any component and feature disclosed herein when the composition is prepared by treating a dirty sand according to a method disclosed herein, and collecting a portion of the treated sand particles that is suitable for use as a proppant.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a schematic diagram of a test apparatus.

FIG. 2 illustrates a graph of test results for Examples 1 to 5.

FIG. 3 illustrates another graph of test results for Examples 6 to 9.

### DETAILED DESCRIPTION

“Dirty sand” refers to sand that contains fines and clay. Fines can have a particle size less than 74 microns. Clay particles can be fines, depending on the size of the clay particles. Fines can include clay or other types of particles, such as silica particles having a particle size that characterize them as fines and not as sand.

Disclosed are chemical additives for sand washing, particularly for preparing sand for fracturing a hydrocarbon reservoir. The methods and compositions disclosed herein utilize a sand obtained by combining a dirty sand with a chemical additive, where the combination decreases the water drain time through the sand compared to the sand without the chemical additive. The decrease of water drain time reduces the amount of time to dry the sand after a wash, and when using the treated sand for proppant (or selected particles sizes of the treated sand for proppant), promotes conductivity of fluid through the sand when the sand is in a fracture of a subterranean formation.

A method for processing sand includes: combining a dirty sand, water, and a chemical additive to form a first mixture having the chemical additive in a range of from 100 ppm to 3,000 ppm (alternatively, 100 ppm to 1,500; alternatively, 250 ppm and 1000 ppm) based on a total weight or a total volume of the first mixture; removing a first portion of the water from the first mixture to form a second mixture; and heating the second mixture to remove a second portion of the water, forming a treated sand. In aspects, water is present in the first mixture in a range of from 15 wt % to 20 wt % based on a total weight of the first mixture, and water is present in the second mixture in a range of from 1 wt % to 5 wt % based on a total weight of the second mixture.

The removing step, also referred to as the intermediate drying step or draining step, alters or agglomerates the fines (also referred to herein as fine particulates) and clay contained in the dirty sand that can reduce conductivity if the dirty sand were used as proppant and not subjected to this process. At least some of the agglomerates can have particle size greater than 74 microns, converting the fines and clay previously present as fines into larger particles in the treated sand. The larger particles can be sorted with larger size particles, for example, when recovering a proppant mixture comprising or consisting of proppant sand and agglomerated particles (clay and fine agglomerates) from the treated sand.

In aspects of the intermediate drying step, drying down to 1 wt % to 3 wt % water based on the weight of the intermediate dried sand results in a similar drying time as is currently experienced in intermediate drying step that goes to 3 wt % to 5 wt % water based on the weight of the intermediate sand without the chemical additive of this disclosure. As a result, less energy is required in a subsequent heating step that follows an intermediate drying step of this disclosure when the chemical additive is present compared to a heating step that follows an intermediate drying step that does not use the chemical additive of this disclosure. In aspects of the intermediate drying step of this disclosure, drying down to 3 wt % to 5 wt % water based on the weight of the intermediate sand results in faster intermediate drying time than is experienced in intermediate drying step drying down to 3 wt % to 5 wt % without presence of the chemical additive, with similar energy required in the heating steps.

In aspects, the intermediate drying step is sped up using chemical additives during the wash step (the combining step) compared to intermediate drying without presence of the chemical additive. The chemical additive can be applied during the washing and/or on the conveyance to the static storage for the intermediate drying stage. Decreasing drying time gives the sand process plants improved efficiencies, while also being able to sell sand faster to potentially realize their own revenue on a shorter time basis. The mode of action of these chemistries in aiding in water drop-out also function to make a higher quality sand product through stabilizing the fine particulates that tend to clog the pore throats of the packed sand, whether in the drying piles, or in proppant pack inside a fracture. In this way, the chemical additive also works to minimize the damage to the conductivity caused by dirty sand (e.g., lower quality or less refined sands). This can lead to a higher potential well production/increased efficiency in hydrocarbon extraction.

In additional aspects, the chemical additive can be introduced to the incoming water source used for fracturing or anywhere else in the system prior to going down the wellbore. Sand quality and processing has been declining in recent years, clays and fine particulate matter are being introduced with the sand, called dirty sand herein. Use of the disclosed techniques also help mitigate the damage to proppant pack conductivity caused by these lower quality dirty sands. For example, the chemical additive could be added in water transfer lines, working tanks (onsite water storage tanks), the blender where the sand and other additives are added, or combinations thereof.

The chemical additive is generally a positively charged molecule, such as a positively charged polymer, a positively charged oligomer, a positively charged surfactant, or a combination thereof. A positively charged molecule can be characterized as a polymer or oligomer depending on the molecule's properties and/or on number of monomer units in the molecule. For example, oligomers can be characterized by a molecule having 2 or 3 monomer units and/or a lower molecular weight, and polymers can be characterized by a molecule having 4 or more monomer units and/or a higher molecular weight. Other definitions and characterizations for oligomer and polymer can be used, depending on the monomer units and the resulting properties (e.g., molecular weight) of the positively charged molecules.

Examples of a positively charged molecule include a positively charged polymeric amine-based compound, a positively charged oligomeric amine-based compound, a zwitterionic polymer, a zwitterionic oligomer, a zwitterionic surfactant, a cationic surfactant, or a combination thereof.

An exemplary type of a positively charged polymeric amine-based compound can be a polymeric quaternized ammonium compound. An example of a polymeric quaternized ammonium compound is a polymeric polydiallyldimethylammonium chloride (polymeric poly (DADMAC)).

An exemplary type of a positively charged oligomeric amine-based compound can be an oligomeric quaternized ammonium compound. An example of a oligomeric quaternized ammonium compound is an oligomeric polydiallyldimethylammonium chloride (oligomeric poly (DADMAC)).

A zwitterionic polymer can contain one type of monomer unit (homopolymer) or different types of monomer units (e.g., copolymer, terpolymer, and so on). Examples of zwitterionic polymers include polybetaines (e.g., polyphosphobetaine, polysulfobetaine, polycarboxybetaine, or combinations thereof).

A zwitterionic oligomer can contain one type of monomer unit. Examples of zwitterionic oligomers include oligomer betaines (e.g., oligomer phosphobetaine, oligomer sulfobetaine, oligomer carboxybetaine, or combinations thereof).

Zwitterionic surfactants can include N,N-dimethyl-N-dodecyl amine oxide, N,N-dimethyl-N-hexadecyl amine oxide, N,N-dimethyl-N-octadecyl amine oxide, N,N-dimethyl-N—(Z-9-octadecenyl)-N-amine oxide, or combinations thereof.

Additionally or alternatively, zwitterionic surfactants can include betaines. Examples of betaines include 2-(dodecyldimethylammonio)acetate (CAS No. 683-10-3), cocoamidopropyl betaine (2-[3-(dodecanoylamino)propyl-dimethylazaniumyl]acetate), dodecanamidopropyl betaine ({2-[3-(dodecanoylamino)propyl]triazan-2-ium-2-yl}acetate), cetyl betaine (2-[hexadecyl(dimethyl)azaniumyl]acetate), oleamidopropyl betaine ((Z)-(carboxymethyl)dimethyl-3-((1-oxo-9-octadecenyl)amino)propylammonium hydroxide), and caprylamidopropyl betaine (2-[dimethyl-[3-(octanoylamino)propyl]azaniumyl]acetate).

Additionally or alternatively, zwitterionic surfactants can include sultaines. Examples of sultanes include lauryl sulfobetaine (3-(dodecyldimethylammonio)propane-1-sulfonate), caprylyl sulfobetaine (3-[decyl(dimethyl)azaniumyl]propane-1-sulfonate), myristyl sulfobetaine (3-[dimethyl(tetradecyl)azaniumyl]propane-1-sulfonate), sulfobetaine 10 (CAS No. 15163-36-7), sulfobetaine 3-14 (N-tetradecyl-N,N-dimethyl-3-ammonio-1-propanesulfonate), sulfobetaine 3-10 (N-decyl-N,N-dimethyl-3-ammonio-1-propanesulfonate); alkylether hydroxypropyl sultaines and alkyldimethylhydroxysultaines such as lauryl hydroxysultaine (3-[dodecyl(dimethyl) ammonio]-2-hydroxypropane-1-sulfonate; 351.55 g/mol; CAS No. 13197-76-7), and myristamidopropyl hydroxysultaine (2-hydroxy-N,N-dimethyl-N-(3-((1-oxotetradecyl)amino) propyl)-3-sulfo-, inner salt).

Additionally or alternatively, zwitterionic surfactants can include phosphate functional zwitterionic surfactants. Examples of phosphate functional zwitterionic surfactants include phosphatidylserines, phosphatidylethanolamines, phosphatidylcholines such as 1-oleoyl-2-palmitoyl-phosphatidylcholine, and sphingomyelins.

In embodiments, the zwitterionic surfactant comprises sulfonate moieties. In embodiments, the zwitterionic surfactant comprises a hydroxyl moiety.

Cationic surfactants can include an alkyl trimethyl quaternary ammonium salt, an alkyl dimethyl benzyl quaternary ammonium salt, a dialkyl dimethyl quaternary ammonium salt, an imidazolinium salt, or a combination thereof.

In aspects, the chemical additive can be utilized in the washing of other minerals or dry products such as silica.

Applications include oil and gas reservoir applications, sand drying, and silica drying.

Aspects include:
positively charged molecules are used to increase the efficiency of sand de-watering, or the drying of the sand;
washing/wet plant and application after wet plant, prior to the intermediate static drying storage;
use of a treated sand, or a portion thereof, as proppant; and
on a well-site, the chemical additive can be added to the source water (ponds/intermediate storage, water transfer lines/pipelines, on-wellsite water storage (working tanks) or the stimulation equipment (blender).

### Examples

Sand dewatering: Sand was rinsed and collected, and moisture content measured by way of Karl Fisher titration or based on a dry mass weight difference. The sand was subjected to a solution of the additive and the timer started. The sand was contained in a way to allow gravity drainage. The moisture was determined at various time intervals to determine the level of static drying and product effect. The initial moisture was 15-20 wt % and the target was 1-5 wt %, preferably 3 wt %.

It was shown that the types of chemical additives disclosed herein were able to decrease the time the sand needed to dry compared to the control and other surfactant products before meeting moisture content KPIs. A chemical additive as disclosed herein showed the best results compared to surfactants and the original process. The results showed a significant drop from the similar trend observed with the other products and dosages tested.

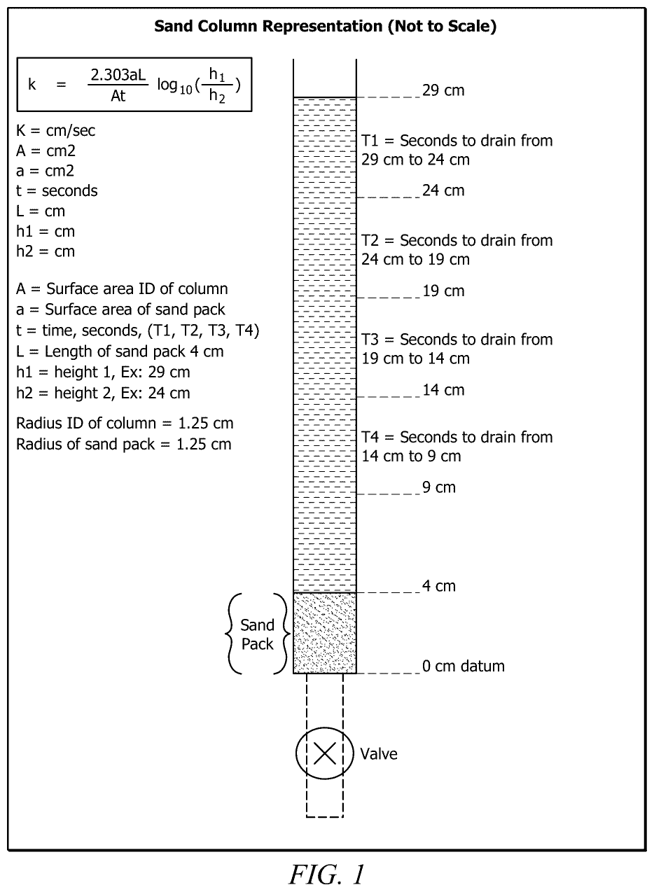

Column Drainage: The column of FIG. 1 was used to test the drain time of water through sand for Examples 1 to 9. The following table describes the procedure used for column drainage tests, and the compositions of the sand in Examples 1 to 9.

| Procedure | Compositions |
|---|---|
| In 30 cm column with a bottom | Example 1: 30 g 100 mesh sand, |
| valve closed, filled with | no chemical additive |
| approximately 7 cm tap water | Example 2: 30 g 100 mesh sand, |
| Bottom end cap of column | 1 GPT (1,000 ppm) Poly |
| with the valve attached had | Quaternary Ammonium Salt |
| bedding to prevent loss of | Example 3: 30 g 100 mesh sand, |
| fines and sand during | 1 GPT (1,000 ppm) Poly |
| drainage | Quaternary Ammonium Salt + |
| Placed column in clamp attached to | Poly(DADMAC) |
| a mixing stand to add remaining | Example 4: 30 g 100 mesh sand, |
| ingredients | 0.25 GPT (250 ppm) Poly |
| Added sand or a mixture of | Quaternary Ammonium Salt + |
| sand/cuttings to the tap water (30 g | Poly(DADMAC) |
| 100 mesh sand for Examples 2 to 5; | Example 5: 30 g 100 mesh sand, |
| 27 g of 100 mesh sand and 3 grams | 0.25 GPT (250 ppm) Poly |
| of 100 mesh cuttings for Examples | Quaternary Ammonium Salt |
| 7 to 9) | Example 6: 27 g 100 mesh sand, |
| Added tap water up to 29 cm on the | 3 g 100 mesh cuttings, no |
| column in FIG. 1, capped the top of | chemical additive |
| column with valve, and closed the | Example 7: 27 g 100 mesh sand, |
| valve | 3 g 100 mesh cuttings, 1 GPT |
| Removed the column from the | (1,000 ppm) Poly Quaternary |
| clamp and inverted the column 20 | Ammonium Salt + |
| times to saturate the solids pack | Poly(DADMAC) |
| and homogenize | Example 8: 27 g 100 mesh sand, |
| The solids pack was moving | 3 g 100 mesh cuttings, 1 GPT |
| and mixing over the entire | (1,000 ppm) Surfactant Mixture |
| length of the column and not | Example 9: 27 g 100 mesh sand, |
| sticking to the bottom portion | 3 g 100 mesh cuttings, 1 GPT |
| of the valve | (1,000 ppm) Zwitterionic Polymer |
| After inversions, placed column | |
| again in the clamp above an | |
| automated scale and allowed 10 | |
| minutes static time for solids pack to | |
| settle under gravity with the top | |
| valve removed | |
| After 10 minutes, simultaneously i) | |
| opened the bottom valve on the | |
| bottom of the column, and ii) started | |
| the automated scale software to | |
| record the weight of the water | |
| drained from column, allowing the | |
| water to drain into a catch beaker | |
| on the scale | |
| Software allowed | |
| visualization of weight of the | |
| water drained into the catch | |
| beaker over time | |
| When column was fully | |
| drained, stopped the | |
| recording of the automated | |
| software | |

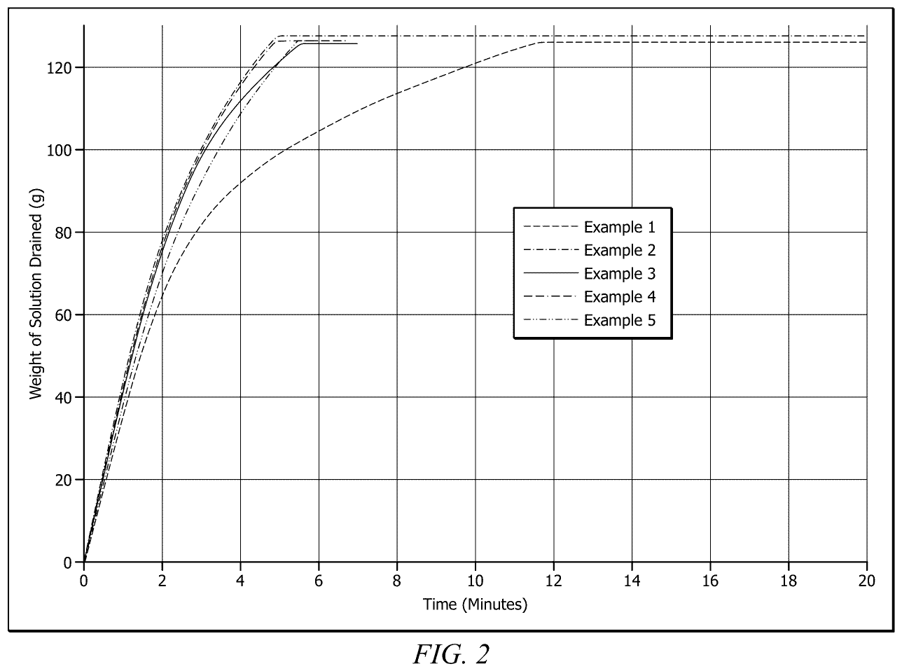

FIG. 2 illustrates the time that it took for the tap water to drain through the sand having a chemical additive disclosed herein (Examples 2 to 5) was lower compared to the time it took for the tap water to drain through the sand in Example 1 that had no chemical additive. Lower drain time (also indicating increased drain rate) compared to no chemical additive was achieved for both high activity (1 GPT, 1,000 ppm of Examples 2 to 3) chemical additive and low activity (0.25 GPT, 250 ppm of Example 4 to 5) chemical additive.

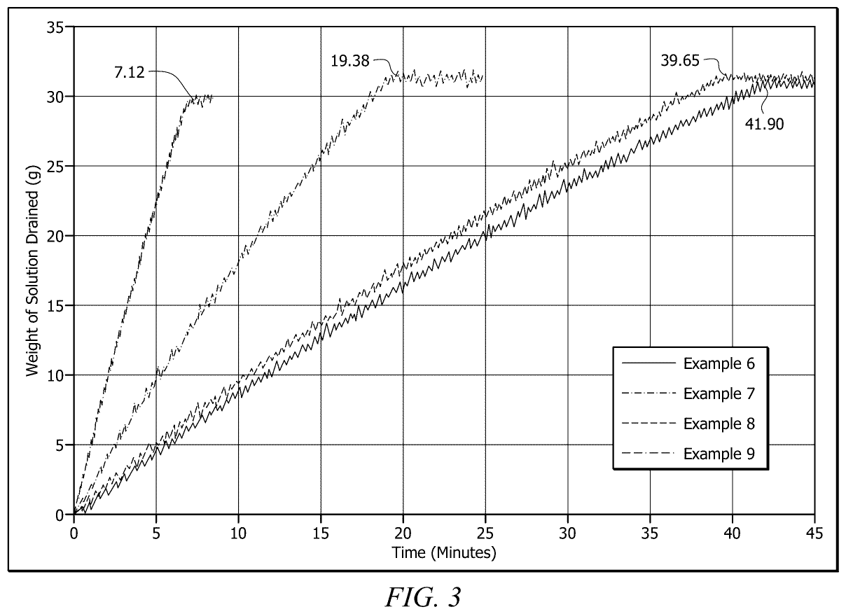

FIG. 3 illustrates that the time for water to drain through the sand was also lower in a sand/cuttings mixture containing 27 g sand and 3 g cuttings (simulating lower quality sand or sand contaminated with clay and fines, 10 wt % based on the total weight of the sand/cuttings). The concentration of the chemical additive was same for Examples 7, 8, and 9, i.e., 1 GPT or 1,000 ppm. The zwitterionic polymer of Example 9 had the lowest water drain time (7.32 minutes), the poly quaternary ammonium salt+poly (DADMAC) of Example 7 had the second lowest water drain time (19.38 minutes), and the surfactant mixture of Example 8 had the third lowest water drain time (39.65 minutes). The water drain time of the blank Example 6 was 41.90 minutes.

The results disclosed herein indicate that use of chemical additive disclosed herein can reduce the time it takes for water to drain from sand and from dirty sand (e.g., having 10 wt % fines and clay), and indicates that conductivity of the packed sand (when used as proppant in fractures) can be improved because the lower quality sand in combination with a chemical additive disclosed herein may have performance of a higher quality, more refined sand would afford.

### Aspects and Features

Feature 1. A method for processing sand, comprising: combining a dirty sand, water, and a chemical additive to form a first mixture comprising the chemical additive in a range of from 100 ppm to 3,000 ppm based on a total weight or a total volume of the first mixture; removing a first portion of the water from the first mixture to form a second mixture; and heating the second mixture to remove a second portion of the water, forming a treated sand. Aspects of Feature 1 can include water being present in a range of from 15 wt % to 20 wt % based on a total weight of the first mixture and water being present in a range of from 1 wt % to 5 wt % based on a total weight of the second mixture.

Feature 2. The method of Feature 1, wherein a period of time to perform the removing with the chemical additive present in the first mixture is less than a period of time to perform the removing for an otherwise similar mixture not having the chemical additive.

Feature 3. The method of Feature 1 or 2, wherein an energy required to perform the heating with the chemical additive is less than an energy required to perform the heating with an otherwise similar mixture not having the chemical additive.

Feature 4. The method of any one of features Feature 1 to 3, performed on a surface of Earth.

Feature 5. The method of Feature 4, wherein the surface of the Earth is located at a sand mine location.

Feature 6. The method of Feature 4 or 5, wherein the surface of the Earth is located at a well site.

Feature 7. The method of any one of Features 1 to 6, further comprising: sorting (or sizing) the treated sand into different particle sizes to obtain a proppant sand or proppant mixture comprising the proppant sand, having a particle size in a range of 74 micron (200 mesh) to 841 micron (20/40 mesh). In aspects, the proppant mixture further comprises agglomerated particles. In aspects, at least some or all of the agglomerated particles can have a particle size in a range of 74 micron (200 mesh) to 841 micron (20/40 mesh).

Feature 8. The method of Feature 7, further comprising: introducing the proppant sand to a fracture in a subterranean formation. In some aspects, the proppant sand is introduced as part of the proppant mixture along with the agglomerated particles.

Feature 9. The method of Feature 8, wherein a conductivity of the proppant sand when in the fracture is greater than a conductivity of the dirty sand when in the fracture.

Feature 10. The method of any one of Features 1 to 9, wherein the chemical additive and the water are combined with the dirty sand simultaneously.

Feature 11. The method of any one of Features 1 to 10, wherein combining comprising: combining the water and the dirty sand to form a first sub mixture; and combining the chemical additive with the first sub mixture to form the first mixture.

Feature 12. The method of any one of Features 1 to 11, wherein the chemical additive comprises a positively charged polymeric amine-based compound, a positively charged oligomeric amine-based compound, a zwitterionic polymer, a zwitterionic oligomer, a zwitterionic surfactant, a cationic surfactant, or a combination thereof.

Feature 13. The method of any one of Features 1 to 12, wherein the first mixture contains the chemical additive in a range of from 100 ppm to 1,500 ppm based on a total weight or a total volume of the first mixture.

Feature 14. The method of any one of Features 1 to 13, wherein the first mixture contains the chemical additive in a range of from 250 ppm to 1,000 ppm based on a total weight or a total volume of the first mixture.

Feature 15. The method of any one of Features 1 to 14, wherein the dirty sand comprises sand and one or more of clay and fines. Additional aspects of Features 1 to 14 can include that treated sand includes agglomerated particles (comprising agglomerates of clays and fines) that form after combining the dirty sand, water, and chemical additive. At least some of the agglomerated particles can have particle size greater than 74 microns.

Feature 16. A method comprising: combining, on a well site, a dirty sand with water and a chemical additive, in any order, to form a proppant mixture; and introducing, on the well site, the proppant mixture into a fracture of a subterranean formation via a wellbore. In aspects, the proppant mixture includes agglomerated particles (comprising agglomerates of clays and fines) that form after combining the dirty sand, water, and chemical additive. At least some of the agglomerated particles can have particle size greater than 74 microns.

Feature 17. The method of Feature 16, wherein the chemical additive comprises a positively charged polymeric amine-based compound, a positively charged oligomeric amine-based compound, a zwitterionic polymer, a zwitterionic oligomer, a zwitterionic surfactant, a cationic surfactant, or a combination thereof.

Feature 18. The method of Feature 16 or 17, wherein the chemical additive is present in a range of from 100 ppm to 3,000 ppm based on a total weight or a total volume of the proppant mixture.

Feature 19. The method of any one of Features 16 to 18, wherein the chemical additive is present in a range of from 100 ppm to 1,500 ppm based on a total weight or a total volume of the proppant mixture.

Feature 20. The method of any one of Features 16 to 19, wherein the chemical additive is present in a range of from 250 ppm to 1,000 ppm based on a total weight or a total volume of the proppant mixture.

Feature 21. The method of any one of Features 16 to 20, wherein the dirty sand comprises sand and one or more of clay and fines.

Feature 22. A composition comprising or consisting of: sand; clay, fines, or both clay and fines; and a chemical additive comprising a positively charged polymeric amine-based compound, a positively charged oligomeric amine-based compound, a zwitterionic polymer, a zwitterionic oligomer, a zwitterionic surfactant, a cationic surfactant, or a combination thereof.

Feature 23. A composition comprising or consisting of: sand; and a chemical additive comprising a positively charged polymeric amine-based compound, a positively charged oligomeric amine-based compound, a zwitterionic polymer, a zwitterionic oligomer, a zwitterionic surfactant, a cationic surfactant, or a combination thereof.

Feature 24. A composition comprising or consisting of: a proppant sand having a particle size in a range of 74 micron (200 mesh) to 841 micron (20/40 mesh); and a chemical additive comprising a positively charged polymeric amine-based compound, a positively charged oligomeric amine-based compound, a zwitterionic polymer, a zwitterionic oligomer, a zwitterionic surfactant, a cationic surfactant, or a combination thereof.

Feature 25. A composition comprising or consisting of: sand having a particle size in a range of 74 micron (200 mesh) to 841 micron (20/40 mesh); and agglomerated particles having a particle size in a range of 74 micron (200 mesh) to 841 micron (20/40 mesh).

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for processing sand, comprising:
combining a dirty sand, water, and a chemical additive to form a first mixture comprising water in a range of from 15 wt % to 20 wt % based on a total weight of the first mixture and the chemical additive in a range of from 100 ppm to 3,000 ppm based on a total weight or a total volume of the first mixture;
removing a first portion of the water from the first mixture to form a second mixture comprising water in a range of from 1 wt % to 5 wt % based on a total weight of the second mixture; and
heating the second mixture to remove a second portion of the water, forming a treated sand.

2. The method of claim 1, wherein a period of time to perform the removing with the chemical additive present in the first mixture is less than a period of time to perform the removing for an otherwise similar mixture not having the chemical additive.

3. The method of claim 1, wherein an energy required to perform the heating with the chemical additive is less than an energy required to perform the heating with an otherwise similar mixture not having the chemical additive.

4. The method of claim 1, performed on a surface of Earth.

5. The method of claim 4, wherein the surface of the Earth is located at a sand mine location.

6. The method of claim 4, wherein the surface of the Earth is located at a well site.

7. The method of claim 1, further comprising:
sorting or sizing the treated sand into different particle sizes to obtain a proppant sand having a particle size in a range of 74 micron (200 mesh) to 841 micron (20/40 mesh).

8. The method of claim 7, further comprising:
introducing the proppant sand to a fracture in a subterranean formation.

9. The method of claim 8, wherein a conductivity of the proppant sand when in the fracture is greater than a conductivity of the dirty sand when in the fracture.

10. The method of claim 1, wherein the chemical additive and the water are combined with the dirty sand simultaneously.

11. The method of claim 1, wherein combining comprises:
combining the water and the dirty sand to form a first sub mixture; and
combining the chemical additive with the first sub mixture to form the first mixture.

12. The method of claim 1, wherein the chemical additive comprises a positively charged polymeric amine-based compound, a positively charged oligomeric amine-based compound, a zwitterionic polymer, a zwitterionic oligomer, a zwitterionic surfactant, a cationic surfactant, or a combination thereof.

13. The method of claim 1, wherein the first mixture contains the chemical additive in a range of from 100 ppm to 1,500 ppm based on a total weight or a total volume of the first mixture.

14. The method of claim 1, wherein the first mixture contains the chemical additive in a range of from 250 ppm to 1,000 ppm based on a total weight or a total volume of the first mixture.

15. The method of claim 1, wherein the dirty sand comprises sand and one or more of clay and fines.

16. A method comprising:
combining, on a well site, a dirty sand with water and a chemical additive to form a proppant mixture; and
introducing, on the well site, the proppant mixture into a fracture of a subterranean formation via a wellbore.

17. The method of claim 16, wherein the chemical additive comprises a positively charged polymeric amine-based compound, a positively charged oligomeric amine-based compound, a zwitterionic polymer, a zwitterionic oligomer, a zwitterionic surfactant, a cationic surfactant, or a combination thereof.

18. The method of claim 16, wherein the chemical additive is present in a range of from 100 ppm to 3,000 ppm based on a total weight or a total volume of the proppant mixture.

19. The method of claim 16, wherein the dirty sand comprises sand and one or more of clay and fines.

20. A composition comprising:
a sand; and
a chemical additive comprising a positively charged polymeric amine-based compound, a positively charged oligomeric amine-based compound, a zwitterionic polymer, a zwitterionic oligomer, a zwitterionic surfactant, a cationic surfactant, or a combination thereof.
